(19) United States
(12) Patent Application Publication
(10) Pub. No.: US 2009/0041409 A1
(43) Pub. Date: Feb. 12, 2009

(54) ELECTRO-OPTICAL PRINTED CIRCUIT BOARD AND A METHOD OF MAKING AN ELECTRO-OPTICAL PRINTED CIRCUIT BOARD

(75) Inventor: Kenneth McPherson HOPKINS, West Sussex (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 12/179,017

(22) Filed: Jul. 24, 2008

Related U.S. Application Data
(60) Provisional application No. 60/954,219, filed on Aug. 6, 2007.

(51) Int. Cl. G02B 6/12; C03B 37/00

(52) U.S. Cl. 385/14; 65/386

(57) ABSTRACT

An electro-optical printed circuit board and a method of making an electro-optical printed circuit board are provided. The method comprises: forming a trench or groove on an outer surface of an electrical printed circuit board; providing optical material in the trench thereby to form an optical waveguide.

### CROSS REFERENCE TO RELATED APPLICATIONS

This application claims priority to U.S. provisional application Ser. No. 60/954,219, filed Aug. 6, 2007, the entire contents of which is incorporated herein by reference.

The present invention relates to an electro-optical printed circuit board and a method of making an electro-optical printed circuit board.

As data rates increase across data networks, there is an increasing need for technologies that can enable the high data rates to be utilised throughout the network. An example of such a technology is the use of optical waveguides and other such optical signal carriers arranged on a conventional electric printed circuit board (PCB). Such a device may be referred to as an electro-optical printed circuit board or “EOPCB”.

An EOPCB contains both metal layers, e.g. copper layers and has one or more optical signal carriers arranged thereon. Naturally, such PCBs are expected to provide the typical functionality of a conventional metal PCB, complemented by the very high speed signal carrying capacity of optical signal carriers.

One method for the fabrication of EOPCBs involves the formation on an outer surface of an electrical PCB of one or more optical waveguides. Methods such as inkjet printing are typically used. Inkjet printing uses droplet deposition to form a continuous optical channel. Since the channel is formed of plural connected droplets of optical material, e.g. optically conductive polymer, the outer wall of the optical signal carrier is typically uneven. An uneven surface on the waveguide wall results in greater optical loss which is undesirable. Furthermore, to form a waveguide from plural droplets of optical material on the surface of an electrical PCB, a particular order of droplet deposition is required. A first droplet preferably is hardened or at least at some defined minimum hardness before a second droplet is provided adjacent to it to continue the formation of the optical waveguide. Thus, the process of optical waveguide formation using inkjet printing on the surface of an electrical PCB is extremely slow.

There are a number of other recognised methods of depositing an optically conductive polymer on an electrical PCB. Some methods, for example those that use photolithographic techniques, require the manufacture of a mask that can result in fast production throughput. Direct write methods using lasers are very slow but have the advantage that no mask is required.

Inkjet printing has been the subject of much recent work and research. There is ongoing research into the possibility of directly depositing conductive materials such as copper or silver onto PCB substrates, such as FR4. Inkjet printing has the advantages of accuracy, low cost, relatively quick turnaround and no mask cost. However, as mentioned above, methods of inkjet printing polymer waveguide structures rely on depositing droplets of polymer which form into a connected structure. The uneven structure of the waveguide edges results in significant loss of light and it is therefore a key disadvantage. In addition, there is the issue that the curing rate of the polymer requires droplets to be deposited out of sequence and within specific time constraints.

Terms such as “upper”, “beneath”, “lower” and other such terms defining a positioning of components when used herein, are generally used with reference to the substrate in which the waveguide is formed. They do not define any absolute configuration since clearly an EOPCB can be configured in use such that any of its surfaces or sides are uppermost etc.

According to a first aspect of the present invention, there is provided a method of making an electro-optical printed circuit board, the method comprising forming a trench on an outer surface of an electrical printed circuit board; providing optical material in the trench thereby to form an optical waveguide.

A method of making an electro-optical printed circuit board is provided in which the problems associated with inkjet formation of an optical waveguide on the surface of an electrical PCB are addressed. Since the waveguide is formed within a trench on an outer surface of the electrical PCB, the trench can be filled with optical material as quickly as possible without having to wait for individual droplets of deposited optical material to achieve certain hardnesses etc.

Preferably, an optically reflective material is provided to line the trench. This has the advantage that the smoothness of the trench when milled does not need to be that great since the lining can produce a smoothing effect. In addition, the optical reflectivity of the lining reduces optical loss from the waveguide and enables a simpler structure of waveguide to be achieved since no optical cladding is necessarily required.

Preferably, the width or depth of the trench may be within the range 25 to 100 μm.

According to a second aspect of the present invention, there is provided an electro optical printed circuit board, comprising: a PCB support having one or more metal layers for providing electrical functionality; and at least one optical waveguide formed within a trench or groove on the PCB support.

Thus, the EOPCB provides both electrical and optical functionality and the at least one waveguide is provided within a trench on the outer surface of the EOPCB. This is a structure that can be manufactured easily and quickly in comparison to known EOPCBs. The one or more metal layers of the PCB may already be configured to provide certain electrical functionality or they may be blanks in that the electrical functionality can be organised or arranged after formation of the at least one waveguide.

Preferably, the trench or groove has a lining of an optically reflective material. This enables optical cladding that is typically provided as part of an optical waveguide to be done away with in certain applications.

Preferably, the optically reflective material is a metal. This is cheap and easy to form within the trench.

Preferably, the waveguide is made up of optical material that substantially fills the trench, such that its upper surface is substantially co-planar with the outer surface of the PCB in which it is formed.

In one example, the waveguide is made up only of an optical core. In another example the waveguide is made up of an optical core and one or more optical cladding layers.

Preferably, the waveguide has a transverse cross section that is one or more of square, rectangular, triangular and semicircular. Any suitable shape can be used. Determining factors are likely to be ease of formation and efficiency of use as an optical signal carrier.

Examples of embodiments of the present invention will now be described with reference to the accompanying drawings, in which:

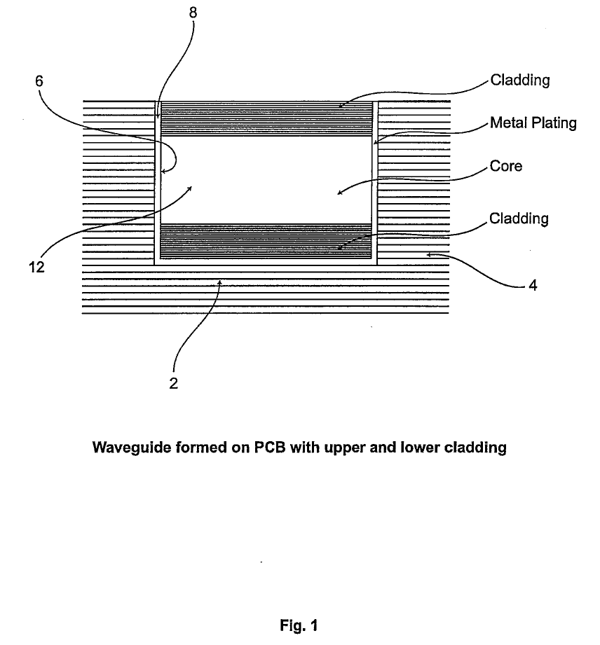

FIG. 1 is a cross-section to a first example of an optical waveguide;

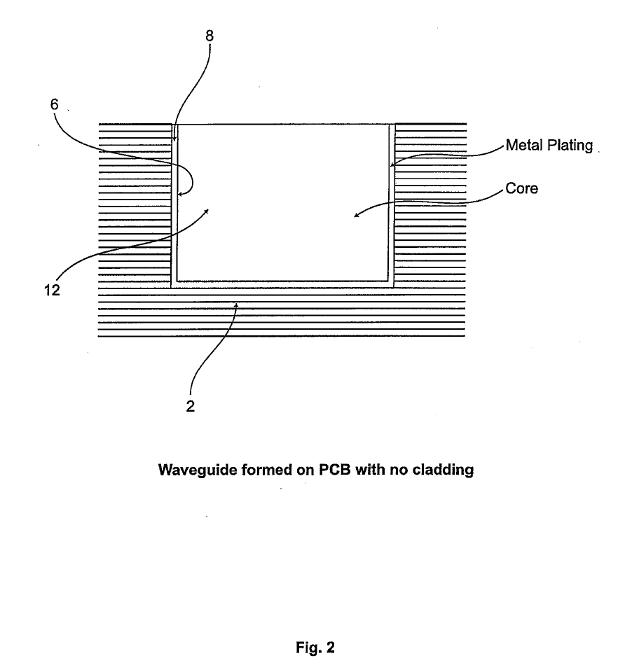

FIG. 2 is a cross-section through a further example of an optical waveguide;

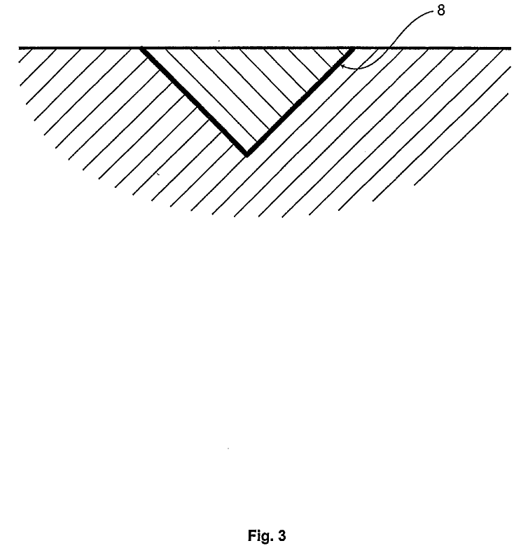

FIG. 3 is a schematic representation of a cross-section through a further example of an optical waveguide; and

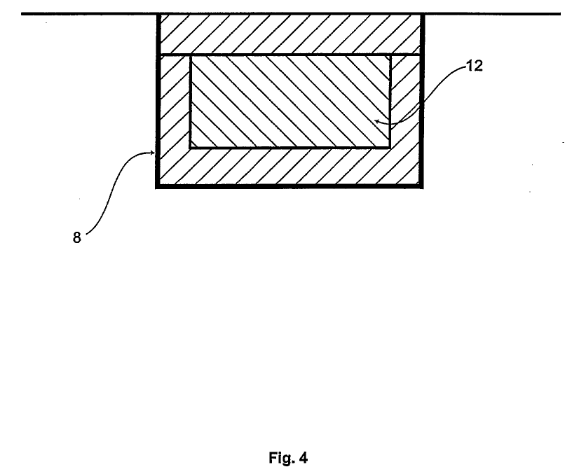

FIG. 4 is a schematic representation of a cross-section through a further example of an optical waveguide.

FIG. 1 is a cross-section through an example of an optical waveguide. The optical waveguide 2 is formed generally as a trench within the outer surface (upper surface as shown in FIG. 1) of a conventional electrical printed circuit board. The electrical printed circuit board 4 may be made of any conventional PCB material, e.g. FR4. The combined structure of the conventional electrical PCB together with the optical waveguide is therefore what may be considered an EOPCB.

In the example shown in FIG. 1, a trench 6 is formed having a reflective lining 8 which provides a boundary to the optical waveguide. The optical waveguide is made up of a first cladding layer 10 at the “bottom” of the trench. An optical core layer 12 is provided on top of the cladding layer 10 and then a second cladding layer 14 is provided such that, in this example, in combination, the optical material fills the trench 6.

During manufacture of a conventional electrical printed circuit board (PCB) a number of fabrication steps are undergone. Typically, on a PCB substrate, etching is performed to create traces, copper pads and lands. Next, drilling is performed to create through holes or vias. Next, milling is performed to create large holes or particular application specific shapes within the FR4 substrate. Next, the pads and lands are metal plated. Next, a solder resist is used to prevent short circuits between surface pads. Last, silk screen printing is used to display text or shapes where required on the surface of the PCB.

According to the present method for making an electro-optical PCB, during the steps of milling and plating, waveguide structures may be formed on the outer layers of the electrical PCB. During the step of milling to create large holes or application specific shapes in the FR4 substrate, grooves or channels are formed on the surface of the PCB. The dimensions of the grooves determine the waveguide profile. Typically, a rectangular or square transverse cross-section may be utilised having each side (in the case of a square) being approximately 70 μm. Typically, the suitable dimensions for each side of the transverse cross section of such a channel or groove would be between 25 and 100 μm. In one example, one dimension is about 70 μm and the other is between 25 and 100 μm. Any suitable cross sectional shape may be used. Other examples include semi- or part-circular, or some other shape that includes a curved part, e.g. half an oval. The waveguide may be a single-mode or a multi-mode waveguide.

After the channels or grooves have been formed having the desired dimensions, a plating process is preferably performed so as to form a metal layer on the sides and base of the milled waveguide channel. A process such as Electroless Nickel Immersion Gold (ENIG) or Immersion Silver may be used to form the metal lining. It is particularly advantageous to form the metal lining of the groove or channel since, depending on its thickness, it can serve to form a smooth surface in comparison to the milled FR4 surface and will therefore form a smoother waveguide wall. In addition, the reflective metal layer will serve to reflect light back into the waveguide core thus reducing optical loss. Therefore, waveguide structures such as that shown in FIG. 1 can be formed easily and conveniently requiring only a small additional step over and above the known steps in formation of an electrical PCB.

Once the groove or channel has been formed and preferably lined with a metallic material, optical material is provided within the channel so as to form the optical waveguide. It is preferred that inkjet type printer technology is used to apply the optical material to the formed channels. Since the channel itself determines the dimensions and shape of the waveguide, the application of optical material is relatively straightforward.

In contrast to surface mounted optical waveguides, i.e. an optical waveguide formed on the surface of an electrical PCB as opposed to within a trench as described herein, a lesser degree of control and is required to lay down the waveguide. The outer bounds of the waveguide are determined by the walls of the groove or channel and therefore the process can be performed much more quickly and with a higher degree of accuracy. In conventional surface printed optical waveguides, droplet deposition of optical material must be performed slowly and carefully to ensure a continuous channel of optical material is formed for signal propagation.

In the example of FIG. 1, the optical waveguide 2 comprises a lower cladding layer 10, an optical core layer 12 and an upper cladding layer 14. It will be appreciated that one or both of the cladding layers can be omitted.

Referring to FIG. 2, a further example of a waveguide on an EOPCB is shown. The structure of the waveguide 2 is similar to that of the waveguide in FIG. 1. However, in this case, no optical cladding layers are provided. The waveguide is made up of a trench 6 lined with a metallic material 8. The entire groove or channel is filled with optical core material 12. The presence of the metallic lining on the groove or channel in this case ensures that even though there is no cladding surrounding the optical core, the waveguide is still able to function with sufficiently low optical loss. In addition, since the boundaries of the waveguide are determined by the dimensions of the groove or trench, the application of the optical material can be performed quickly and without the same degree of control as required for optical waveguides formed using conventional methods on an outer surface as opposed to within a trench cut into the surface of an electrical PCB.

Any suitable means may be used to form the groove or trench within the electrical PCB. One example includes the use of laser milling. In fact, any suitable form of milling may be used. In a preferred embodiment, a method is provided of generating optical waveguides on an electrical PCB using conventional inkjet printing techniques in combination with micro-milling to create an accurate, cheap and fast method of manufacture.

FIGS. 3 and 4 show alternatives types of optical waveguides used forming the present method. Referring to FIG. 3, a V-shape channel is formed. In this case, a metallic lining 8 has been provided. No optical cladding is provided, the optical material being composed entirely of optical core material. Upper and/or lower cladding could of course be used if required.

Referring to FIG. 4, in this case a full (upper and lower) optical cladding is provided around the optical core 12. Although not necessary in many applications due to the presence of the metallic lining 8, there may be certain situations in which it is desired to provide an optical cladding surrounding the optical core 12. The lower cladding in this example is in the form of a “bathtub” cladding in that it provides cladding both “beneath” and at the “sides” of the optical core 12.

Embodiments of the present invention have been described with particular reference to the examples illustrated. However, it will be appreciated that variations and modifications may be made to the examples described within the scope of the present invention.

1. A method of making an electro-optical printed circuit board, the method comprising:
forming a trench on an outer surface of an electrical printed circuit board;
providing optical material in the trench thereby to form an optical waveguide.

2. A method according to claim 1, in which the step of forming the trench comprises milling the trench into the surface of the electrical printed circuit board.

3. A method according to claim 2, in which step of forming the trench comprises cutting the trench into the surface of the electrical printed circuit board using a laser cutter.

4. A method according to claim 1, comprising lining the trench with an optically reflective material after the trench has been formed and before optical material is provided in the trench.

5. A method according to claim 4, in which the optically reflective material is a metal.

6. A method according to claim 1, in which the step of providing optical material in the trench comprises laying down the optical material using ink jet printing.

7. A method according to claim 1, in which the step of providing optical material in the trench comprises laying down a layer of optical cladding material and then, laying down a layer of optical core material.

8. A method according to claim 1, in which optical material is provided to substantially fill the trench.

9. A method according to claim 1, in which the trench is formed to have a width of between 25 and 100 μm.

10. An electro optical printed circuit board, comprising:
a PCB support having one or more metal layers to provide electrical functionality; and
at least one optical waveguide formed within a trench on the PCB support.

11. An electro optical printed circuit board according to claim 10, in which the trench has a lining of an optically reflective material.

12. An electro optical printed circuit board according to claim 11, in which the optically reflective material is a metal.

13. An electro optical printed circuit board according to claim 10, in which the waveguide is made up of optical material that substantially fills the trench, such that its upper surface is substantially co-planar with the outer surface of the PCB in which it is formed.

14. An electro optical printed circuit board according to claim 10, in which the waveguide is made up only of an optical core.

15. An electro optical printed circuit board according to claim 10, in which the waveguide is made up only of an optical core and one or more optical cladding layers.

16. An electro optical printed circuit board according to claim 10, in which the waveguide has a transverse cross section that is one or more of square, rectangular, triangular and semicircular.
